(19) United States
(12) Patent Application Publication
(10) Pub. No.: US 2011/0126441 A1
(43) Pub. Date: Jun. 2, 2011

(54) MAGAZINE DEPENDENT SAFETY MECHANISM OF A HANDGUN

(75) Inventor: Marko Vukovic, Karlovac (HR)

(73) Assignee: HS Produkt D.O.O., Karlovac (HR)

(21) Appl. No.: 13/003,892

(22) PCT Filed: Jul. 22, 2009
(86) PCT No.: PCT/HR09/00026

§ 371 Date: Jan. 13, 2011

(30) Foreign Application Priority Data
Jul. 25, 2008 (HR) P20080372A
Aug. 21, 2008 (HR) P20080409A

(51) Int. Cl. F41A 17/36; F41A 17/64; B23P 19/00; B23P 11/00

(52) U.S. Cl. 42/70.02; 29/426.1; 29/428

(57) ABSTRACT

The invention discloses a safety mechanism of a handgun which depends on a magazine and which prevents the triggering of a handgun when the magazine is removed. Additionally, a mechanism enables handgun disassembly without need for the triggering after the magazine has been removed from the handgun. A safety mechanism is positioned inside the handgun receiver; including a magazine, sear catcher, sear catcher spring, grip safety pin, sear, sear pin, firing pin safety lever and firing pin. When the magazine is inserted into the handgun, the sear catcher is pushed into position in which it cannot block the firing pin safety lever nor catch the sear. When the magazine is removed from the handgun, the sear catcher spring pushes the sear catcher into position in which it blocks the firing chain by blocking the firing pin safety lever. At the same time it brings the sear catcher into position where it can hold the sear below the plane of the cocking of the firing pin as soon as the sear is sufficiently rotated around the sear pin by retracting the slide.

### FIELD OF THE INVENTION

The subject invention refers to the handgun safety mechanism that is magazine dependent. The subject invention belongs to the field of inventions which prevent the triggering of a handgun when the magazine is not inserted into a handgun, and which, in addition, allow for the disassembly of a handgun without triggering when the magazine is removed.

### TECHNICAL PROBLEM

The first technical problem this subject invention solves is preventing the triggering of a handgun when the magazine is removed. Namely, it is known and often happens in practice that a gun operator assumes that the handgun is not loaded once operator removes the magazine, but a round can remain in the barrel and it can cause accidental firing.

Another technical problem that is at the same time solved by this subject invention is the construction of the mechanism of a handgun that allows for the handgun to be disassembled without triggering as soon as the magazine is removed. It is known that the disassembly of a handgun with a cocked firing pin leads to the triggering of the handgun in the process of disassembly. Every such triggering poses a risk of an accidental firing of the round that remained in the barrel upon triggering which is a necessary part of the disassembly, and which is completely avoided by this subject invention.

### STATE OF ART

In the patent literature we find a significant number of technical solutions regarding the first technical problem—the prevention of the triggering of a handgun with a removed magazine. The solution provided by a patent U.S. Pat. No. 4,031,648 (Frank S. Thomas) from 1975 solves the above mentioned basic technical problem. The given technical solution solves the primary technical problem in a different way, but it does not solve the second technical problem—the problem of disassembly without triggering.

Regarding the second technical problem—the disassembly of a handgun without triggering—the closest technical solution is found in the international patent PCT/HR2009/000023 (HS PRODUKT d.o.o.). The said technical solution solves only the second technical problem—the disassembly of a handgun without triggering—but it does not solve the first technical problem—the prevention of the triggering of a handgun with a removed magazine.

### THE SUMMARY OF THE INVENTION

The subject invention prevents the triggering of the handgun once the magazine has been removed, and also enables the disassembly of the handgun without the need for subsequent triggering after the removal of the magazine. This safety mechanism is positioned inside the receiver and it consists of: the magazine, sear catcher, sear catcher spring, grip safety pin, the sear, sear pin, firing pin safety lever and the firing pin. According to the invention, this mechanism enables the following:
when the magazine is inserted, the sear catcher is pushed into position in which it cannot block the firing pin safety lever nor can it catch the sear; and
when the magazine is removed from the handgun, the sear catcher spring pushes the sear catcher into position in which it blocks the firing chain by blocking the firing pin safety lever; at the same time, the sear catcher is brought into position in which it can hold the sear beneath the plane of the cocking of the firing pin as soon as the sear is sufficiently rotated around the sear pin by retracting the slide.

### BRIEF DESCRIPTION OF THE FIGURES

In FIGS. 1-13 two possible embodiments of the subject invention are shown;

variant “A”—the one that solves both the first and the second technical problem, and

variant “B”—solves only the second technical problem.

When the letter “A” appears with a number of a figure, it represents variant “A” of the technical solution; e.g. 3A, and when the letter is “B”, it represents variant “B” of the technical solution according to the invention.

FIG. 1 shows spatial layout of the mechanism in the A or B variant.

FIG. 2 shows the layout of the handgun elements as seen by the operator prior to the disassembly, when the magazine is inserted. FIGS. 3A and 3B (variant A and variant B of the invention) show a situation when the magazine is inserted. FIGS. 4A and 4B show the same situation as 3A and 3B, only with more detail and a clearer spatial layout of the elements of the invention.

FIG. 5 shows the spatial layout of the elements of a handgun as seen by the operator when the magazine is removed, while FIGS. 6A and 7A (variant A) show a situation when the magazine is removed in relation to the corresponding situation 3A and 4A when the magazine is inserted (in the A variant).

FIG. 8 shows the layout of the elements of a handgun as seen by the operator after the magazine has been removed, the disassembler rotated and the slide pulled backwards. FIGS. 9A and 9B show the position of the mechanism according to the subject invention, FIGS. 10A and 10B show the same situation as 9A and 9B, only from more positions and with a clearer spatial layout.

FIG. 11 shows the position of the slide and the layout of elements before the slide is removed from the receiver. FIGS. 12A and 12B, as well as FIGS. 13A and 13B, show the interrelated positions of functional parts and show why the firing pin does not get cocked during the disassembly.

### A DETAILED DESCRIPTION OF THE INVENTION

It was mentioned earlier that the basic technical problem that the subject invention solves is preventing the triggering of a handgun when the magazine is removed. Unfortunately, the practice of firearm usage is full of accidents related to accidental firings caused by the operator's carelessness or ignorance. According to the subject invention, triggering is immediately prevented when the magazine is removed from the handgun because the firing chain is blocked. Technical solution according to the subject invention also allows for the disassembly of a handgun without triggering as soon as the magazine is removed.

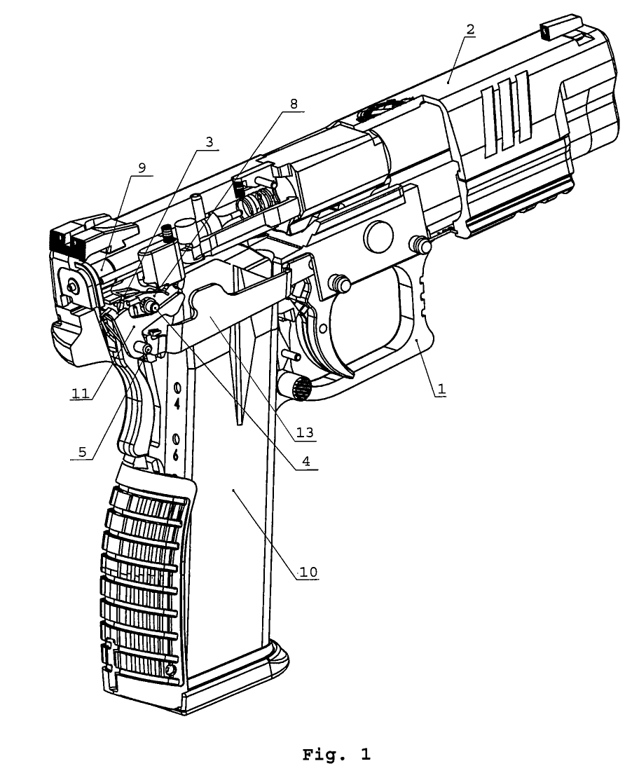

The layout of the handgun elements is shown in FIG. 1; the slide (2) is positioned on the receiver (1), while the mechanism itself consists of the sear (3), sear pin (4), grip safety pin (5), the firing pin (9), the magazine (10), sear catcher (11) and the activating lever (13) of the triggering mechanism.

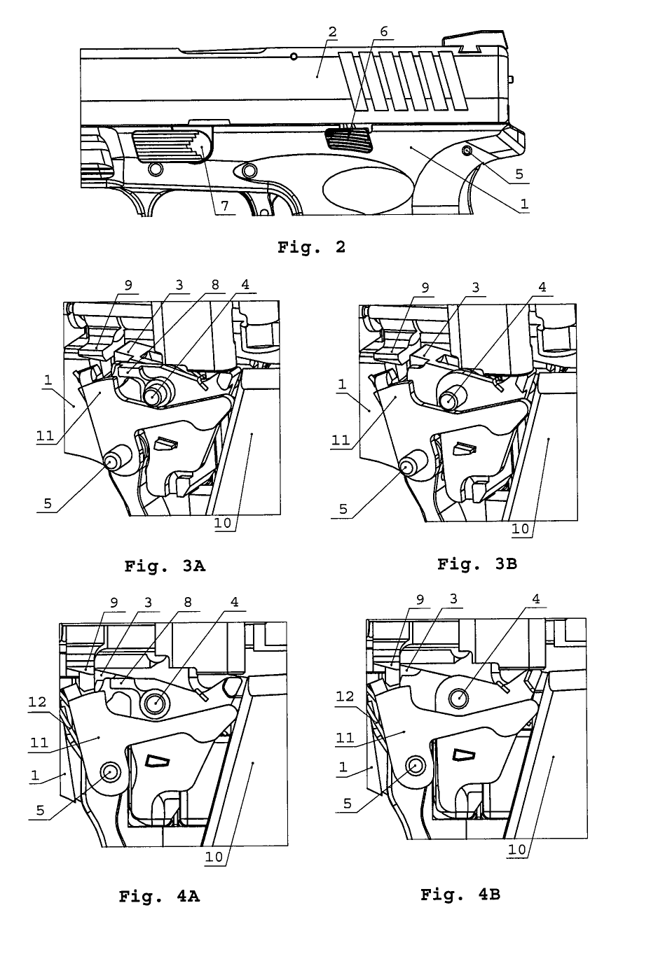

FIG. 2 shows the situation before the beginning of a disassembly of a handgun; the disassembler (7) is not activated, slide stop lever (6) is not in a position where it detains the slide (2), the magazine (10) is inserted into a handgun. The mechanism according to the subject invention is conceived in such a way that the sear catcher (11) can move in rotation around the grip safety pin (5) in a way that it is constantly pushed towards the magazine (10) by a sear catcher spring (12). FIGS. 3A and 3B show how the body of a magazine (10) holds the sear catcher (11) which leans on the magazine (10) and leaves the sear catcher (11) in a position which:
does not enable the catching and the holding of the sear (3) (variants “A” and

“B”), and
does not block the firing pin safety lever (8), which is only possible according to the “A” variant of the invention.

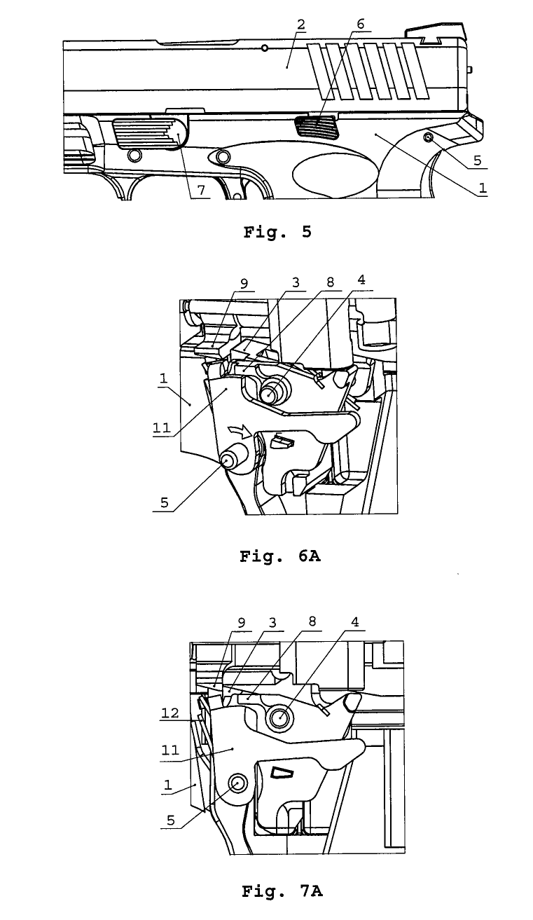

FIG. 5 shows a situation which is, from the operator's perspective, different from FIG. 2 only in that the magazine (10) is removed from a handgun—the magazine cannot be seen because it is positioned inside the receiver (1). It is visible from FIG. 6A that the sear catcher spring (12) now pushes and rotates the sear catcher (11) around the grip safety pin (5) (in the direction of the arrow in FIG. 6A) in a way that:
the sear catcher (11) abuts the sear (3) (variant “A” and “B”) but it does not perform the catching of the sear (3), i.e. the firing pin (9) is still beneath the plane of the sear (3) and it latches onto it—FIG. 7A; and
in case of the embodiment according to the variant “A”, the sear catcher (11) partly slides under the firing pin safety lever (8) and blocks its moving around the sear pin (4), which is not possible according to the “B” variant of the invention in which the firing pin safety lever (8) is not activated.

In case of the embodiment according to the “A” variant of the invention, the firing chain is thus blocked; the activation lever (13) can no longer move the firing pin safety lever (8) which is blocked by the sear catcher (11) prong, which solves the first technical problem of the invention—prevention of the triggering of the handgun when the magazine is removed.

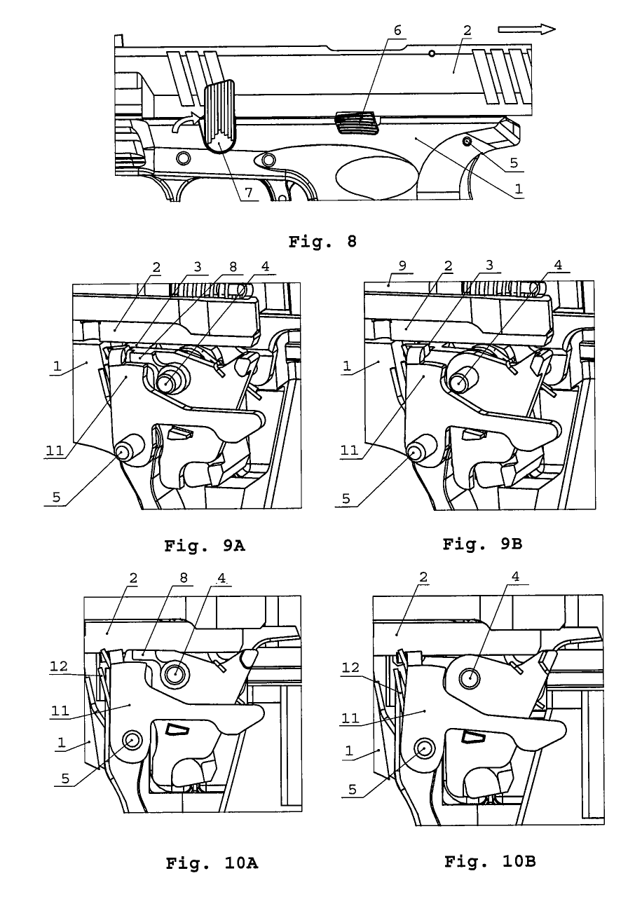

In order to continue with the disassembly, it is necessary to move the disassembler (7) as shown in FIG. 8 and pull the slide (2) backwards (in the direction of the arrow) until the slide is detained on the slide stop lever (6). Prior to pulling the slide (2) backwards—the magazine (10) was removed at the previous stage, and the sear catcher (11) abuts the sear (3). The retracting of the slide (2) rotates the sear (3) counterclockwise around the sear pin (4) which bring the sear (3) into position to be caught by the sear catcher (11). In the moment when the sear (3) is sufficiently pushed, the sear catcher (11) which is pushed by the spring (12) catches and holds the sear (3) with its prong—the sear is held in that position, while at the same time the sear catcher prong slides more deeply under the firing pin safety lever (8) (only in the variant “A” of the invention)—FIGS. 9A, 9B and 10A, 10B. The firing pin (9) can no longer get cocked on the sear (3) when the sear (3) is caught in that position (FIG. 10A and 10B) by the sear catcher (11).

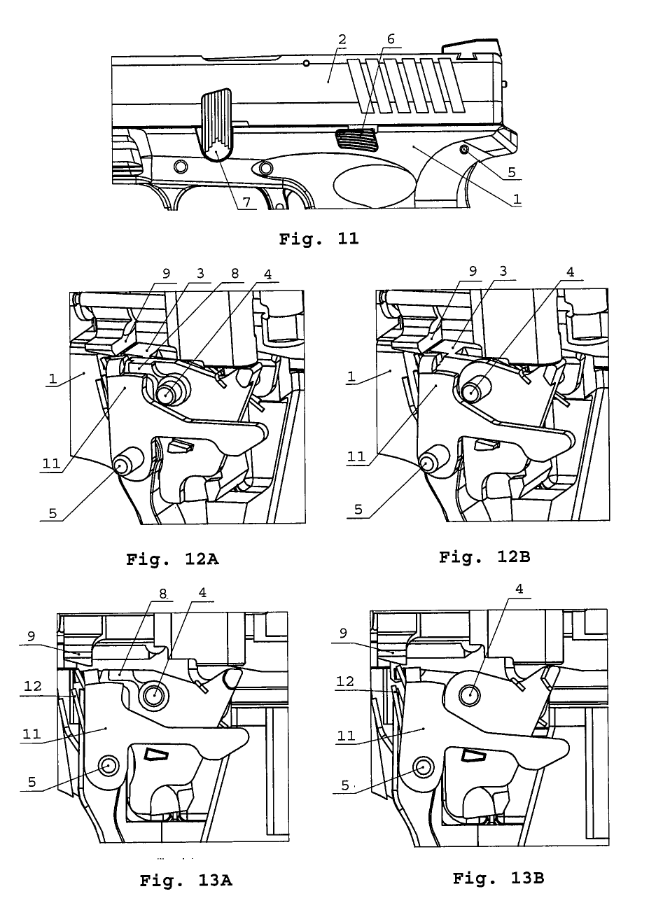

Now it is possible to push the slide (2) into position shown in FIG. 11 and remove it from the receiver (1) by moving it forwards. The sear (3) is blocked beneath the plane of cocking of the firing pin (9), and the firing pin safety lever (8) (in the “A” variant of the invention) is entirely blocked by the moving of the sear catcher (11) which is pushed by the spring (12)—FIGS. 12A, 12B, 13A and 13B. Thus the disassembly of a handgun is performed without triggering since there was no cocking of the firing pin (9).

This solves the second technical problem—constructing the mechanism of a handgun that would allow for the handgun to be disassembled without triggering as soon as the magazine is removed.

The assembly of a handgun is performed by the reverse procedure.

It is clear from the figures and descriptions that the releasing of the sear (3) and the firing pin safety lever (8) (for the variant “A” of the invention) can only happen at the moment when the slide (2) is in its default position and the magazine (10) is inserted. Only when the magazine (10) is inserted will the sear catcher (11) be pushed into position shown in FIGS. 3A and 3B and the normal functioning of the handgun will be enabled, i.e. the firing chain in case of the “A” variant of the invention will be unblocked by releasing the firing pin safety lever (8).

### INDUSTRIAL APPLICABILITY

It is easy to incorporate this magazine-dependant safety mechanism into a handgun. Its feature is that through a small number of additional parts it achieves the desired technical function—preventing the triggering when the magazine is removed and the disassembly without triggering. Therefore, invention applicability as such is unquestionable and it contributes to the safety of handling the said gun at the stage of maintaining/cleaning a handgun and changing a magazine.

### REFERENCES

(1) receiver
(2) slide
(3) sear
(4) sear pin
(5) grip safety pin
(6) slide stop lever
(7) disassembler
(8) firing pin safety lever
(9) firing pin
(10) magazine
(11) sear catcher
(12) sear catcher spring
(13) activation lever

1.-4. (canceled)

5. A handgun safety mechanism dependent on a magazine that prevents triggering of a handgun when the magazine is removed and enables the handgun disasembly without need for decocking of a firing pin after the magazine is removed; a safety mechanism is positioned inside the handgun receiver and comprising: a magazine, a sear catcher, a sear catcher spring, a grip safety pin, a sear, a sear pin, firing pin safety lever and firing pin wherein:
when the magazine is inserted, the sear catcher is pushed by the magazine into position where it cannot block the firing pin safety lever nor catch the sear; and
when the magazine is removed from the handgun, the sear catcher is pushed by the sear catcher spring into position in which it blocks the firing chain by blocking the firing pin safety lever, and at the same time the sear is caught by a sear catcher when the sear is pressed downwards upon retracting the slide.

6. A handgun safety mechanism dependent on a magazine according to claim 5, which enables the handgun with a removed magazine to be disassembled without need for decocking of the firing pin by retracting the slide onto the slide stop lever; wherein retracting the slide pushes the sear around the sear pin beneath the plane of the cocking of the firing pin, the sear catcher spring additionally pushes the sear catcher which catches the sear and holds it below the plane of the firing pin that prevents cocking of the firing pin during the activation of the dissasembler and removing the slide from the receiver by moving it forward.

7. A method for disasembly of a handgun without triggering equipped with a handgun safety mechanism dependent on a magazine, the method comprising:
A. removing a magazine from the handgun, that blocks the firing pin safety lever and thus interrupts the firing chain;
B. retracting a slide onto a slide stop lever which enables a sear catcher to hold a sear beneath a plane of a cocking of a firing pin,
C. activation of a disassembler, and
D. removing the slide from the receiver by moving it forward.

8. A method for assembly of a handgun by using the handgun safety mechanism dependent on a magazine that is performed in a reverse order from the method of claim 7 wherein the final insertion of the magazine into the handgun pushes the sear catcher to release the sear so that the sear can again reach the plane of cocking of the firing pin, and the sear catcher unblocks the firing pin safety lever.
